(19) United States
(12) Patent Application Publication
(10) Pub. No.: US 2025/0014577 A1
(43) Pub. Date: Jan. 9, 2025

(54) INFORMATION PROCESSING METHOD, INFORMATION PROCESSING DEVICE, AND INFORMATION PROCESSING PROGRAM

(71) Applicant: Sony Group Corporation, Tokyo (JP)

(72) Inventors: Masahiro TAKAHASHI, Kanagawa (JP); Mitsuhiro MIYAZAKI, Kanagawa (JP); Kenichiro NOTAKE, Tokyo (JP)

(73) Assignee: Sony Group Corporation, Tokyo (JP)

(21) Appl. No.: 18/710,993

(22) PCT Filed: Dec. 5, 2022
(86) PCT No.: PCT/JP2022/044733

§ 371 Date: May 16, 2024

(30) Foreign Application Priority Data
Dec. 17, 2021 (JP) 2021-204935

(51) Int. Cl. G10L 15/22; G06T 11/20

(52) U.S. Cl. CPC G10L 15/22; G06T 11/206; G10L 2015/223

(57) ABSTRACT

In an information processing method performed by a computer (200) comprises: displaying plan information, the plan information representing a future plan and being generated based on basic information on a user and an ideal plan of the user in consultation on the future plan of the user through a voice interaction; and correcting the future plan and updating the plan information in accordance with information on reaction of the user to the plan information that has been displayed.

### FIELD

The present disclosure relates to an information processing method, an information processing device, and an information processing program.

### BACKGROUND

In consultation with an expert on a future plan of a user, the future plan is created by meeting the expert. For example, in the field of life insurance, the user meets a life planner and a financial planner (hereinafter, LP/FP), and creates a life plan chart. Furthermore, there is proposed a method of creating the life plan chart in which, for example, various pieces of information are input with a keyboard and a mouse to create a life plan sheet and the soundness of the created life plan sheet is evaluated (Patent Literature 1).

### CITATION LIST

### Patent Literature

Patent Literature 1: JP 2020-60819 A

### SUMMARY

### Technical Problem

In the above-described conventional technique, however, a life plan chart is created based on information input by a user with a keyboard and a mouse, so that a question of the user and a sudden question are difficult to be reflected in the life plan chart.

Therefore, the present disclosure proposes an information processing method, an information processing device, and an information processing program that enables immediate check of plan information reflecting utterance contents.

### Solution to Problem

According to the present disclosure, an information processing method performed by a computer comprises: displaying plan information, the plan information representing a future plan and being generated based on basic information on a user and an ideal plan of the user in consultation on the future plan of the user through a voice interaction; and correcting the future plan and updating the plan information in accordance with information on reaction of the user to the plan information that has been displayed.

### BRIEF DESCRIPTION OF DRAWINGS

FIG. 1 illustrates one example of a configuration of an information processing system according to an embodiment of the present disclosure.

FIG. 2 illustrates one example of an exchange between a user and an AI agent.

FIG. 3 illustrates one example of the exchange between the user and the AI agent.

FIG. 4 illustrates one example of reflecting information on a line of sight of the user in a chart.

FIG. 5 illustrates one example of a configuration of a terminal device according to the embodiment of the present disclosure.

FIG. 6 illustrates one example of a configuration of a server according to the embodiment of the present disclosure.

FIG. 7 illustrates one example of a user basic information input screen.

FIG. 8 illustrates one example of a life event input screen.

FIG. 9 illustrates one example of an income and expenditure simulation screen.

FIG. 10 illustrates one example of an explanation screen and a life plan chart screen.

FIG. 11 illustrates one example of a timeline display.

FIG. 12 illustrates one example of the timeline display using a graph.

FIG. 13 is a flowchart illustrating one example of chart generation processing.

FIG. 14 is a sequence diagram illustrating one example of processing related to an exchange between the user and the AI agent in Case 1.

FIG. 15 is a sequence diagram illustrating one example of processing related to an exchange between the user and the AI agent in Case 2.

FIG. 16 is a sequence diagram illustrating one example of processing related to an exchange between the user and the AI agent in Case 3.

FIG. 17 is a hardware configuration diagram illustrating one example of a computer that implements the function of an information processing device.

### DESCRIPTION OF EMBODIMENTS

An embodiment of the present disclosure will be described in detail below with reference to the drawings. Note that, in the following embodiment, the same reference signs are attached to the same parts to omit duplicate description.

The present disclosure will be described in the following item order.

1. Embodiment

1-1. Configuration of System According to Embodiment

1-2. Example of Interaction Created by AI Agent

1-3. Configuration of Terminal Device According to Embodiment

1-4. Configuration of Server According to Embodiment

1-5. Procedure of Information Processing According to Embodiment

1-6. Flow of Processing in Interaction Created by AI agent

2. Variations of Embodiment

3. Hardware Configuration

4. Effects

### (1. Embodiment)

### [1-1. Configuration of System According to Embodiment]

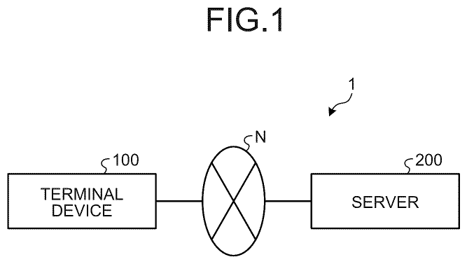

FIG. 1 illustrates one example of a configuration of an information processing system according to the embodiment of the present disclosure. As illustrated in FIG. 1, an information processing system 1 includes a terminal device 100 and a server 200. The terminal device 100 and the server 200 are connected via, for example, a network N.

The terminal device 100 is an information processing device operated by a user who creates a life plan chart. The terminal device 100 transmits information on the user to an artificial intelligence (AI) agent that operates in the server 200, and displays a response of the AI agent and the created life plan chart, for example. The server 200 is an information processing device that provides service of creating a life plan chart. The server 200 operates the AI agent, and creates the life plan chart, for example. Note that a chart and the life plan chart are examples of plan information. Furthermore, details of each device will be described later. Moreover, in an exchange between the user and the AI agent, an operation inside the information processing system 1 may be represented as an operation of the AI agent.

### [1-2. Example of Interaction Created by AI Agent]

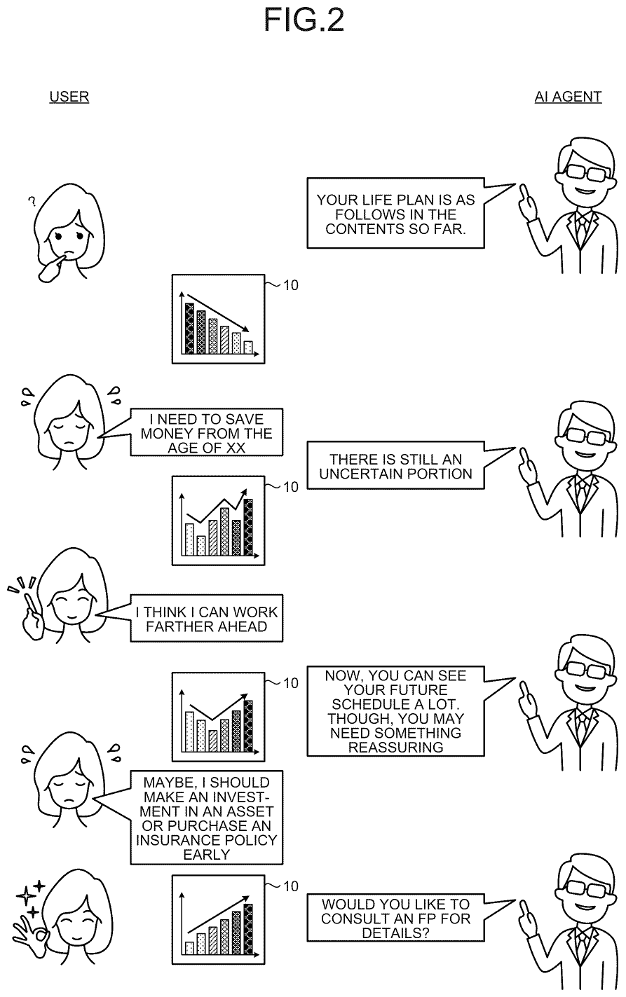

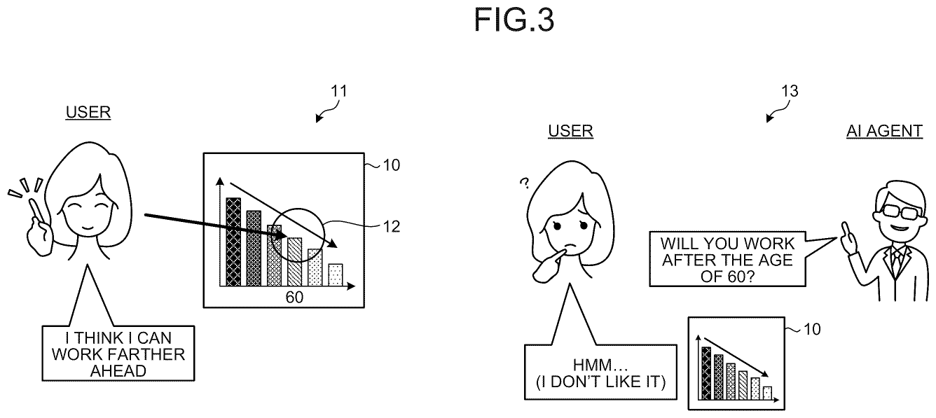

First, an example of an interaction between the user and the AI agent assumed in the embodiment will be described with reference to FIGS. 2 to 4. FIGS. 2 and 3 illustrate one example of the exchange between the user and the AI agent. As illustrated in FIG. 2, the AI agent receives input regarding user basic information such as the age and annual income of the user who creates the life plan chart and an ideal future plan of the user. The AI agent then presents a life plan chart 10 based on the input contents. Thereafter, the AI agent presents the life plan chart 10 in which the future plan is corrected based on user utterance contents in a conversation with the user. The AI agent presents the life plan chart 10 suitable for the future plan corrected by repeating a conversation with the user, and proposes consulting an LP/FP for details.

In the conversation between the user and the AI agent in FIG. 3, as illustrated in a situation 11, the AI agent may detect a line of sight of the user with a camera provided on the terminal device 100, and acquire information on where in the life plan chart 10 the user is looking. In the situation 11, the user says “I think I can work farther ahead” while looking at a region 12 near the age of 60 in the life plan chart 10. That is, the AI agent can acquire information of “age of 60” from the line of sight of the user together with the saying of “I think I can work farther ahead”. Furthermore, the AI agent may detect an expression of the user with the camera when asking the user a question of “Will you work after the age of 60?” while displaying the life plan chart 10 in which the asset balance decreases as illustrated in a situation 13, for example. In this case, the AI agent determines that the user ambiguously says “Hmm . . . ” but has a negative feeling since the detected expression is cloudy. The AI agent can adjust the next question.

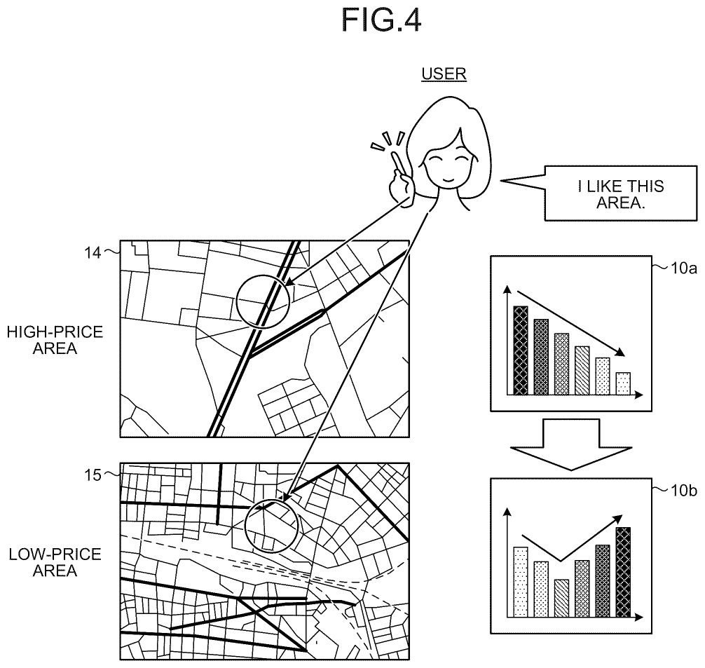

FIG. 4 illustrates one example of reflecting information on a line of sight of the user in a chart. As illustrated in FIG. 4, when detecting a line of sight of the user looking at a map 14 of a high-price area in house purchase, the AI agent generates and displays a life plan chart 10a in which a house purchase price is changed in accordance with the land price of the map 14. When detecting a line of sight of the user looking at a map 15 of a low-price area while looking at the life plan chart 10a to operate map display and acquiring an utterance content of “I like this area.”, the AI agent generates and displays a life plan chart 10b in which the house purchase price is changed in accordance with the land price of a map 15. That is, the AI agent can dynamically change the life plan chart 10 based on information of voice and a line of sight.

In contrast, in the above-described conventional technique, a life plan chart is created based on information input by a user with a keyboard and a mouse, and the soundness of the created life plan chart is evaluated. Since an interaction with the AI agent is not created, however, a life plan chart does not reflect a content unintentionally said by the user. This makes it difficult to create a better life plan chart while checking a life plan chart reflecting the content easily said by the user.

The information processing system 1 according to the present disclosure executes information processing described below in order to enable immediate check of a chart reflecting the utterance content. Specifically, the information processing system 1 generates and displays a chart representing the future plan based on the user basic information and the ideal plan of the user in consultation on the future plan of the user through a voice interaction. The information processing system 1 corrects the future plan and updates the chart in accordance with information on reaction of the user to the displayed chart.

### [1-3. Configuration of Terminal Device According to Embodiment]

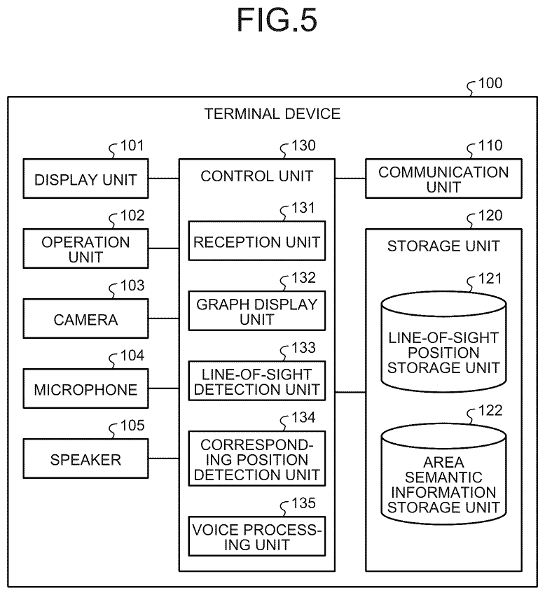

FIG. 5 illustrates one example of a configuration of a terminal device according to the embodiment of the present disclosure. As illustrated in FIG. 5, the terminal device 100 includes a display unit 101, an operation unit 102, a camera 103, a microphone 104, a speaker 105, a communication unit 110, a storage unit 120, and a control unit 130. Examples of the terminal device 100 include a personal computer and a smartphone.

The display unit 101 is a display device for displaying various pieces of information. The display unit 101 is implemented by, for example, a liquid crystal display and an organic electro luminescence (EL) display as the display device. The display unit 101 displays various screens such as a user basic information input screen, a product/term explanation screen, and a life plan chart screen.

The operation unit 102 is an input device that receives various operations from the user who operates the terminal device 100. The operation unit 102 is implemented by, for example, a keyboard, a mouse, and a touch panel as an input device. The operation unit 102 receives input of basic information such as the age and annual income from the user. Note that the display device of the display unit 101 and the input device of the operation unit 102 may be integrated like a display with a touch panel.

The camera 103 images the user who operates the terminal device 100. For example, the camera 103 captures an image by using a complementary metal oxide semiconductor (CMOS) image sensor or a charge coupled device (CCD) image sensor serving as an imaging element. The camera 103 performs photoelectric conversion and A/D conversion on light received by the imaging element to generate an image. The camera 103 outputs the captured image to the control unit 130.

The microphone 104 acquires voice of the user who operates the terminal device 100. Various microphones such as an electret condenser microphone can be used as the microphone 104. The microphone 104 outputs a voice signal of the acquired voice to the control unit 130.

The speaker 105 outputs the content of an utterance of the AI agent. Various speakers such as a dynamic type speaker and a capacitor type speaker can be used as the speaker 105. The speaker 105 outputs sound based on the voice signal input from the control unit 130.

The communication unit 110 is implemented by, for example, a network interface card (NIC) and a wireless local area network (LAN) such as Wi-Fi (registered trademark). The communication unit 110 is a communication interface that is connected to the server 200 by wire or wirelessly via the network N and that manages information communication with the server 200. For example, the communication unit 110 receives, from the server 200, data such as information on a result of semantic analysis by voice recognition, data of various screens, graph information, and voice signals from the AI agent. Furthermore, the communication unit 110 transmits input information, voice information, captured images, instructions to the AI agent, and the like to the server 200.

The storage unit 120 is implemented by, for example, a semiconductor memory element, such as a random access memory (RAM) and a flash memory, and a storage device, such as a hard disk and an optical disk. The storage unit 120 includes a line-of-sight position storage unit 121 and an area semantic information storage unit 122. Furthermore, the storage unit 120 stores information (programs and data) to be used for processing in the control unit 130.

The line-of-sight position storage unit 121 stores the position of a line of sight of the user detected from the captured image captured with the camera 103. For example, the line-of-sight position storage unit 121 stores a line-of-sight position in a screen displayed on the display unit 101 in a time-series history.

The area semantic information storage unit 122 stores what kind of information is displayed in a predetermined area on the screen displayed on the display unit 101 while associating the area in the screen with displayed information. For example, the area semantic information storage unit 122 stores an area of a graph for the age of 60 in the displayed life plan chart and information of “age of 60” in association with each other.

The control unit 130 is implemented by, for example, a central processing unit (CPU) and a micro processing unit (MPU) executing a program stored in an internal storage device by using a RAM as a work area. Furthermore, the control unit 130 may be implemented by an integrated circuit such as an application specific integrated circuit (ASIC) and a field programmable gate array (FPGA).

The control unit 130 includes a reception unit 131, a graph display unit 132, a line-of-sight detection unit 133, a corresponding position detection unit 134, and a voice processing unit 135. The control unit 130 implements or executes the function and effect of information processing to be described below. Note that the internal configuration of the control unit 130 is not limited to the configuration in FIG. 5. Other configurations may be adopted as long as the configurations perform information processing to be described later.

The reception unit 131 displays, on the display unit 101, a user basic information input screen, a personality diagnosis screen, and an input screen of an ideal future plan (hereinafter, also referred to as ideal plan), which have been received from the server 200 via the network N and the communication unit 110. The reception unit 131 receives inputs of basic information, personality diagnosis information, and ideal plan information from the user on the user basic information input screen, the personality diagnosis screen, and the ideal plan input screen displayed on the display unit 101. Examples of the user basic information include information such as age, annual income, and whether married or not. Examples of the personality diagnosis information include a response to a question in Big Five and the like. Examples of the ideal plan information include the age of purchasing a car and a house and a goal of life savings. That is, the ideal plan information is life plan data indicating future hope of the user. Occurrence of an event, income and expenditure for each age, savings, and the like serve as parameters. The reception unit 131 transmits the received user basic information, personality diagnosis information, and ideal plan information to the server 200 via the communication unit 110 and the network N.

The graph display unit 132 generates life plan chart drawing data based on the graph information received from the server 200 via the network N and the communication unit 110, and causes the display unit 101 to display a life plan chart screen. Furthermore, the graph display unit 132 stores what kind of information is displayed in a predetermined area on the displayed screen in the area semantic information storage unit 122 while associating the area in the screen with displayed information. Note that the graph display unit 132 may cause the display unit 101 to display another screen such as a document screen related to a life plan.

The line-of-sight detection unit 133 detects a line of sight of the user based on the captured image input from the camera 103. The line-of-sight detection unit 133 determines a line-of-sight position in the screen displayed on the display unit 101 based on the detected line of sight. The line-of-sight detection unit 133 outputs the determined line-of-sight position to the corresponding position detection unit 134 while storing the determined line-of-sight position in the line-of-sight position storage unit 121. Furthermore, the line-of-sight detection unit 133 may detect the expression of the user based on the input captured image, and transmit expression data to the server 200 via the communication unit 110 and the network N.

When the line-of-sight detection unit 133 inputs the line-of-sight position, the corresponding position detection unit 134 acquires semantic information of an area having the line-of-sight position with reference to the area semantic information storage unit 122. The corresponding position detection unit 134 transmits the line-of-sight position and the area semantic information to the server 200 as graph parameters via the communication unit 110 and the network N.

The voice processing unit 135 samples the voice signal input from the microphone 104, and generates voice information. The voice processing unit 135 transmits the generated voice information to the server 200 via the communication unit 110 and the network N. The voice processing unit 135 receives semantic analysis result information corresponding to the transmitted voice information from the server 200 via the network N and the communication unit 110. The voice processing unit 135 transmits the semantic analysis result information to the server 200 as a graph parameter via the communication unit 110 and the network N. Note that the semantic analysis result information may be directly output from a voice engine unit 240 to a graph processing unit 220 in the server 200, which will be described later. Furthermore, the voice processing unit 135 outputs, to the speaker 105, a voice signal based on utterance information of the AI agent received from the server 200 via the network N and the communication unit 110.

### [1-4. Configuration of Server According to Embodiment]

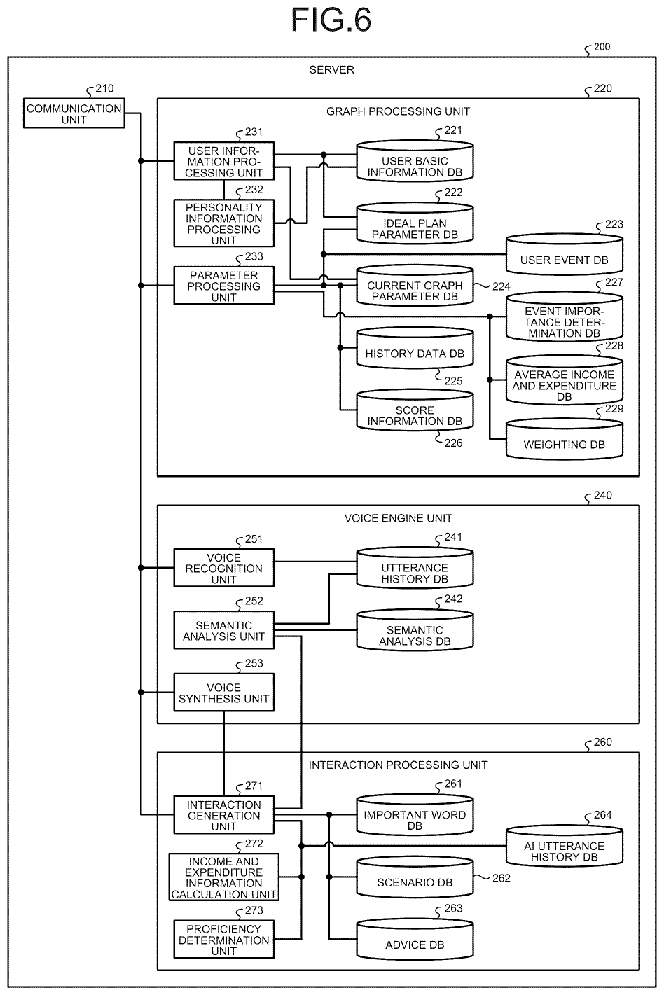

FIG. 6 illustrates one example of a configuration of a server according to the embodiment of the present disclosure. As illustrated in FIG. 6, the server 200 includes a communication unit 210, the graph processing unit 220, the voice engine unit 240, and an interaction processing unit 260. Each processing unit included in the graph processing unit 220, the voice engine unit 240, and the interaction processing unit 260 is implemented by, for example, a CPU and an MPU executing a program stored in the internal storage device using a RAM as a work area. Furthermore, each processing unit included in the graph processing unit 220, the voice engine unit 240, and the interaction processing unit 260 may be implemented by an integrated circuit such as an ASIC and an FPGA.

Furthermore, each database (hereinafter, also referred to as DB) included in the graph processing unit 220, the voice engine unit 240, and the interaction processing unit 260 is included in a storage unit (not illustrated), and implemented by, for example, a semiconductor memory element, such as a RAM and a flash memory, and a storage device, such as a hard disk and an optical disk. Furthermore, the storage unit stores information (programs and data) to be used for processing in each processing unit included in the graph processing unit 220, the voice engine unit 240, and the interaction processing unit 260.

The communication unit 210 is implemented by, for example, an NIC and a wireless LAN such as Wi-Fi (registered trademark). The communication unit 210 is a communication interface that is connected to the terminal device 100 by wire or wirelessly via the network N and that manages information communication with the terminal device 100. For example, the communication unit 210 receives, from the terminal device 100, input information, voice information, captured images, and instructions to the AI agent. Furthermore, the communication unit 210 transmits, to the terminal device 100, data such as information on a result of semantic analysis by voice recognition, data of various screens, graph information, and voice signals from the AI agent.

The graph processing unit 220 includes databases of: a user basic information DB 221; an ideal plan parameter DB 222; a user event DB 223; a current graph parameter DB 224; a history data DB 225; a score information DB 226; an event importance determination DB 227; an average income and expenditure DB 228; and a weighting DB 229. Note that each DB can also be accessed from the voice engine unit 240 and the interaction processing unit 260.

The user basic information DB 221 stores personal data and information on the personality of the user. The user has input the personal data in the terminal device 100. The personal data includes the name, age, sex, annual income, and profession of the user. A personality information processing unit 232 to be described later determines the personality of the user.

The ideal plan parameter DB 222 stores various pieces of information in the ideal plan input by the user in the terminal device 100, for example, information on a retirement allowance, income and expenditure for each age, and nursing care.

The user event DB 223 stores event information obtained in creating the life plan chart, for example, information on marriage, childbirth, family structure, retirement allowance, and retirement age assumed at the present time.

The current graph parameter DB 224 stores parameters of the currently displayed life plan chart. The current graph parameter DB 224 stores information such as an expenditure amount, an income amount, and a saving amount for each age as a parameter.

The history data DB 225 stores a history of a parameter of the life plan chart stored in the current graph parameter DB 224. The history data DB 225 is referred to when a history of update of the life plan chart is displayed in a timeline.

The score information DB 226 stores a basic point for each parameter of the life plan chart to be referred to when a score representing a level of satisfying the ideal plan is calculated by comparing the currently displayed life plan chart with the ideal plan. In the score information DB 226, examples of the parameter of a comparison element include current and future income and expenditure information, family structure, a housing loan, investment, and personal preferences such as hobbies. Furthermore, the score information DB 226 may store scores corresponding to respective events of the currently displayed life plan chart and a total score.

The event importance determination DB 227 stores the importance of each event obtained in creating the life plan chart. For example, the event importance determination DB 227 stores the fact that a retirement allowance event is an income event with high importance. The importance can be set in three stages of high, medium, and low for each event, for example.

The average income and expenditure DB 228 stores information such as an amount, the age of pay, and importance of the retirement allowance as past statistical data. That is, the average income and expenditure DB 228 stores a parameter of an average life plan chart for each of a plurality of model cases.

The weighting DB 229 stores weighting information for changing the weighting of a parameter of the life plan chart in specific utterance of the user and an interaction scenario with the AI agent. For example, when a luxury food store is used in a certain scenario, the weighting DB 229 stores information for changing the weighting of a parameter of annual income so as to raise the annual income, for example, weighting information of increasing the annual income by 1.1 times. Furthermore, for example, when the information on the personality of the user indicates prudence, the weighting DB 229 stores information for reducing expenditure, for example, weighting information of increasing the expenditure by 0.9 times.

Next, each processing unit in the graph processing unit 220 will be described. The graph processing unit 220 includes a user information processing unit 231, the personality information processing unit 232, and a parameter processing unit 233.

The user information processing unit 231 transmits data of the user basic information input screen to the terminal device 100 via the communication unit 210 and the network N, and causes the terminal device 100 to display the user basic information input screen. The user information processing unit 231 acquires the user basic information input on the displayed basic information input screen. For example, a wizard method can be used for the user basic information input screen. The user information processing unit 231 stores the acquired user basic information in the user basic information DB 221. Furthermore, the user information processing unit 231 may cover lacked information with a model case closest to the user basic information with reference to the average income and expenditure DB 228.

Moreover, the user information processing unit 231 transmits data of a personality diagnosis screen to the terminal device 100 via the communication unit 210 and the network N, and causes the terminal device 100 to display the personality diagnosis screen. The user information processing unit 231 acquires the personality diagnosis information input on the displayed personality diagnosis screen. The user information processing unit 231 outputs the acquired personality diagnosis information to the personality information processing unit 232.

Furthermore, the user information processing unit 231 transmits data of the ideal plan input screen to the terminal device 100 via the communication unit 210 and the network N, and causes the terminal device 100 to display the ideal plan input screen. The user information processing unit 231 acquires the ideal plan information input on the displayed ideal plan input screen. The user information processing unit 231 stores the acquired ideal plan information in the ideal plan parameter DB 222.

Moreover, the user information processing unit 231 calculates an initial value of a parameter of a life plan chart based on the user basic information, a personality diagnosis result, and a model case with reference to the user basic information DB 221 and the average income and expenditure DB 228. For example, the user information processing unit 231 calculates an initial value of a parameter of a life plan chart reflecting common income and expenditure information from the current age to the age of 90 based on an age, annual income, and a model case. Furthermore, the user information processing unit 231 may calculate the initial value of the parameter of the life plan chart in consideration of event information included in the ideal plan information with reference to the ideal plan parameter DB 222. Note that the balance of income and expenditure may be in deficit in the life plan chart in which the parameter is set as the initial value. The user information processing unit 231 stores the calculated parameter of the life plan chart in the current graph parameter DB 224 and the history data DB 225. Furthermore, the user information processing unit 231 transmits the calculated parameter of the life plan chart to the terminal device 100 as graph information via the communication unit 210 and the network N.

When the user information processing unit 231 inputs personality diagnosis information, the personality information processing unit 232 diagnoses the personality of the user based on the input personality diagnosis information, and stores the personality diagnosis result in the user basic information DB 221. Examples of elements of the personality diagnosis result include openness, honesty, extroversion, cooperativeness, and a neurotic tendency.

The parameter processing unit 233 recalculates the parameter of the life plan chart in accordance with user reaction information based on an interaction between the AI agent that operates in the interaction processing unit 260 and the user. That is, an interaction scenario in the interaction between the AI agent that operates in the interaction processing unit 260 and the user and information on a result of semantic analysis by voice recognition in the voice engine unit 240 are input to the parameter processing unit 233. The parameter processing unit 233 recalculates the parameter of the life plan chart based on the interaction scenario and the semantic analysis result information. The parameter processing unit 233 transmits the recalculated parameters of the life plan chart to the terminal device 100 as graph information via the communication unit 210 and the network N.

The parameter processing unit 233 refers to the user basic information DB 221 to the weighting DB 229 at the time of recalculation of the parameter. Note that, in FIG. 6, a part of the connection between each processing unit and each DB is omitted. Specifically, the parameter processing unit 233 determines a user event and updates the user event DB 223 based on the semantic analysis result information. For example, when the voice engine unit 240 inputs semantic analysis result information on a house purchasing event, the parameter processing unit 233 changes a house purchasing event in the user event DB 223 into a checked state, and sets attributes included in the semantic analysis result information, such as a price, an age, and a form of the house.

The parameter processing unit 233 estimates a parameter affecting a life plan based on a line-of-sight position and area semantic information, which are included in a graph parameter received from the terminal device 100 via the communication unit 210 and the network N, and the semantic analysis result information. The parameter processing unit 233 updates the user event DB 223 by using the estimation result. For example, the parameter processing unit 233 sets attributes of an age and an amount of a retirement allowance in the user event DB 223 based on the fact that the user is looking at an area of the age of 65 and information on a result of semantic analysis regarding a user utterance of a retirement allowance of 20 million yen.

When updating the user event DB 223, the parameter processing unit 233 may determine the weighting of the semantic analysis result information with reference to the weighting DB 229. For example, when the user responds that he/she often shops at a luxury food store, the parameter processing unit 233 can increase annual income by 10% from a model case of the average income and expenditure DB 228. Furthermore, for example, the parameter processing unit 233 may change the weighting in accordance with attributes such as the educational background and the place of employment of the user.

The parameter processing unit 233 calculates a parameter of a new life plan chart based on the updated user event DB 223 and the current parameter of the current graph parameter DB 224. The parameter processing unit 233 stores the calculated parameter of the new life plan chart in the current graph parameter DB 224 and the history data DB 225 while transmitting the parameter to the terminal device 100 as graph information via the communication unit 210 and the network N. Note that the parameter processing unit 233 may calculate the parameter of the new life plan chart with reference to the current expression of the user based on a captured image acquired from the terminal device 100, the proficiency of the user in creating a life plan based on the semantic analysis result information, information on the personality of the user stored in the user basic information DB 221, and the like.

The parameter processing unit 233 may compare a parameter in an ideal plan in the ideal plan parameter DB 222 with the parameter of the new life plan chart stored in the current graph parameter DB 224 to calculate a score of the parameter of the new life plan chart. The parameter processing unit 233 stores the calculated score in the score information DB 226. For example, when data on a certain event is lacked, the parameter processing unit 233 may lower the score regarding the event. Note that the score stored in the score information DB 226 can be used for timeline display and the like. Furthermore, the parameter processing unit 233 may add an attribute of, for example, performing highlight display to a score of an event related to a topic for which a lot of interaction time has been spent.

Subsequently, the voice engine unit 240 will be described. The voice engine unit 240 includes databases of an utterance history DB 241 and a semantic analysis DB 242. Note that each DB can also be accessed from the graph processing unit 220 and the interaction processing unit 260.

The utterance history DB 241 stores, in time series, a character string (sentence) of an utterance of the user for which voice recognition has been performed by a voice recognition unit 251 to be described later.

The semantic analysis DB 242 stores learned data in which association between an operation command (domain goal: DG) obtained by converting the context of the character string or analyzing the character string and a corresponding slot for each attribute has been learned. For example, it is assumed that slots “AGE_SLOT”, “VALUE_SLOT”, and “TYPE_SLOT” are associated with a DG “HOUSING”. In this case, a semantic analysis unit 252 to be described later determines “DG: HOUSING” by DG conversion from a character string “purchase a detached house of 80 million yen at the age of 40.”, and acquires information such as “AGE_SLOT: 40”, “VALUE_SLOT: 80 million”, and “TYPE_SLOT: detached house” by using a corresponding slot of the semantic analysis DB 242.

Next, each processing unit in the voice engine unit 240 will be described. The voice engine unit 240 executes voice recognition and voice synthesis in the operation of the AI agent. The voice engine unit 240 includes the voice recognition unit 251, the semantic analysis unit 252, and a voice synthesis unit 253.

The voice recognition unit 251 performs voice recognition on voice information received from the terminal device 100 via the communication unit 210 and the network N, executes end detection and transcription, and generates a character string of a user utterance. The voice recognition unit 251 stores the generated character string of a user utterance in the utterance history DB 241 while instructing the semantic analysis unit 252 to execute semantic analysis.

When instructed to execute semantic analysis by the voice recognition unit 251, the semantic analysis unit 252 acquires a character string of the latest user utterance with reference to the utterance history DB 241. The semantic analysis unit 252 generates semantic analysis result information by performing DG conversion and slot extraction on the acquired character string. In the above-described example of the semantic analysis DB 242, “DG: HOUSING”, “AGE_SLOT: 40”, “VALUE_SLOT: 80 million”, and “TYPE_SLOT: detached house” are generated as the semantic analysis result information. The semantic analysis unit 252 transmits the generated semantic analysis result information to the terminal device 100 via the communication unit 210 and the network N. Note that the semantic analysis unit 252 may output the generated semantic analysis result information to an interaction generation unit 271 to be described later of the interaction processing unit 260 in the server 200.

When the AI agent that operates in the interaction processing unit 260 inputs an uttered sentence, the voice synthesis unit 253 generates utterance information by voice synthesis. The voice synthesis unit 253 transmits the generated utterance information to the terminal device 100 via the communication unit 210 and the network N.

Subsequently, the interaction processing unit 260 will be described. The interaction processing unit 260 includes databases of an important word DB 261, a scenario DB 262, an advice DB 263, and an AI utterance history DB 264. Note that each DB can also be accessed from the graph processing unit 220 and the voice engine unit 240.

The important word DB 261 stores a word important for generating a life plan chart in the user utterance content together with weighting information in accordance with importance.

The scenario DB 262 stores a scenario, which is a conversation flow including what kind of question should be asked next at the time when the AI agent interacts with the user. The scenario can be selected from a plurality of scenarios based on, for example, lacked information and information input as an ideal plan.

The advice DB 263 stores information on advice to be given to the user in accordance with the progress of the scenario stored in the scenario DB 262. Examples of the advice include the content such as “Would you like to consult an LP?” for a part in deficit in the life plan chart.

The AI utterance history DB 264 stores sentences of the contents uttered by the AI agent in time series.

Next, each processing unit in the interaction processing unit 260 will be described. The interaction processing unit 260 executes processing of interacting with the user as the AI agent. The interaction processing unit 260 includes the interaction generation unit 271, an income and expenditure information calculation unit 272, and a proficiency determination unit 273.

The interaction generation unit 271 is a processing unit that interacts with the user as the AI agent. The interaction generation unit 271 determines whether or not the user has given utterance within a predetermined time based on the semantic analysis result information received from the terminal device 100 or the semantic analysis result information input from the voice engine unit 240. When determining that the user has not given utterance within the predetermined time, the interaction generation unit 271 selects a scenario of interacting with the user as the AI agent with reference to the scenario DB 262. The interaction generation unit 271 asks a question to the user in accordance with the selected scenario. The interaction generation unit 271 may change the scenario selection and the question content in accordance with the proficiency and literacy of the user in life plan creation. Note that, in the following description, the interaction generation unit 271 that operates as the AI agent is assumed to perform voice recognition and voice synthesis in the voice engine unit 240, and individual descriptions thereof will be omitted.

The interaction generation unit 271 acquires the user utterance content and line-of-sight information from the terminal device 100. The user utterance content is a response to the question. The line-of-sight information includes a line-of-sight position at the time of utterance and area semantic information. Similarly, when determining that the user has given utterance within the predetermined time, the interaction generation unit 271 acquires an utterance content and line-of-sight information from the terminal device 100. The line-of-sight information includes a line-of-sight position at the time of utterance and area semantic information. Note that the predetermined time for waiting for utterance of the user may be changed in accordance with user personality information stored in the user basic information DB 221 and the literacy related to a life plan.

The interaction generation unit 271 determines whether or not the acquired user utterance content is a question. When the user utterance content is not a question, the interaction generation unit 271 instructs the parameter processing unit 233 to correct a parameter of the life plan chart in accordance with the utterance content and the line-of-sight information and update the life plan chart. At this time, the interaction generation unit 271 outputs the interaction scenario and the semantic analysis result information to the parameter processing unit 233. The interaction generation unit 271 generates an interaction such as a response suitable for the corrected life plan chart.

In contrast, when the user utterance content is a question, the interaction generation unit 271 responds with reference to each DB such as the scenario DB 262 and the advice DB 263 in accordance with the utterance content and the line-of-sight information. The interaction generation unit 271 determines whether or not the current scenario has ended, that is, whether or not to end chart generation processing. When the chart generation processing is not to be ended, the interaction generation unit 271 waits for a user utterance, or proceeds to the next item of the scenario and continues to interact with the user. In contrast, when determining to end the chart generation processing, the interaction generation unit 271 notifies the user that the generation of the life plan chart is to be ended, and ends the processing. Note that data of the generated life plan chart may be transmitted to a terminal possessed by the user by e-mail or the like, or may be printed by a printer (not illustrated).

Furthermore, the interaction generation unit 271 may determine whether the user utterance content is in a chat phase or in a consultation phase. In this case, when determining that the user utterance content is in the chat phase, the interaction generation unit 271 does not give a question and a response to the user. When determining that the user utterance content is in the consultation phase, the interaction generation unit 271 gives a question and a response to the user. Moreover, when a certainty factor of semantic analysis on a user utterance content is low or the chart greatly changes, the interaction generation unit 271 may give a response for making a check to the user. Furthermore, when there is a plurality of users, the interaction generation unit 271 identifies a decision maker in accordance with an utterance contributing to the life plan chart and the number of utterances. Note that the decision maker may be distinguished depending on a topic, such that a decision maker in a topic is a father, and is a mother in another topic. The interaction generation unit 271 may instruct the parameter processing unit 233 to update the life plan chart in accordance with the content of an utterance of the identified decision maker. Moreover, the interaction generation unit 271 may perform filter processing through weighting on important words and sentences included in the user utterance content.

The income and expenditure information calculation unit 272 determines whether or not there is an age in deficit based on income and expenditure for each age and savings in the current life plan chart with reference to the current graph parameter DB 224. When determining that there is an age in deficit, the income and expenditure information calculation unit 272 instructs the interaction generation unit 271 to cause the AI agent to ask a question indicating that there is an age in deficit. When determining that there is not an age in deficit, the income and expenditure information calculation unit 272 notifies the interaction generation unit 271 that there is no age in deficit.

The proficiency determination unit 273 determines the proficiency of the user in life plan creation and whether or not the user has literacy based on an interaction between the user and the AI agent with reference to the utterance history DB 241 and the AI utterance history DB 264. The proficiency determination unit 273 notifies the interaction generation unit 271 of results of determinations of the proficiency and the literacy.

Here, an example of an interaction created by the AI agent will be described. For example, the interaction generation unit 271 selects a scenario of generating an interaction regarding an event that has not been input with reference to the user event DB 223 and the scenario DB 262. For example, when a house purchase event has not been input, the AI agent asks questions such as “When do you hope to buy a house?” and “How much of a property would you like?”.

Furthermore, for example, the interaction generation unit 271 selects a scenario of generating an interaction regarding an event that is at a place where the user is looking and that has not been input with reference to a line-of-sight position at the time of an utterance of the user, the area semantic information, the user event DB 223, and the scenario DB 262. For example, when the user is looking at a part of the age of 60 in the life plan chart and a retirement allowance event is not set, the AI agent asks a question such as “Would you like to set a retirement allowance?”.

Furthermore, for example, the interaction generation unit 271 extracts a characteristic part in the current life plan chart with reference to the current graph parameter DB 224. Examples of the characteristic part include a part with income and expenditure in deficit about which the income and expenditure information calculation unit 272 has given an instruction. The interaction generation unit 271 selects a scenario suitable for the extracted characteristic part with reference to the scenario DB 262. At this time, the interaction generation unit 271 may give advice with reference to the advice DB 263. For example, when a part of the age of 50 has a deficit, the AI agent gives advice such as “Would you like to consult an LP about the deficit of the age of 50?”.

Furthermore, for example, the interaction generation unit 271 may select a scenario in accordance with the personality of the user based on the user personality information with reference to the user basic information DB 221 and the scenario DB 262. For example, when the user has a high sense of optimism, the AI agent asks a question such as “How often will you travel abroad after retirement?”.

Furthermore, for example, when expression data can be acquired from the terminal device 100, the interaction generation unit 271 may select a scenario from the scenario DB 262 in combination with the line-of-sight position and the area semantic information. For example, when the user is looking at an educational fund for a child with a troubled expression, the AI agent asks a question such as “Are you worried about an educational fund for your child?” and “would you like to set an educational fund for your child?”.

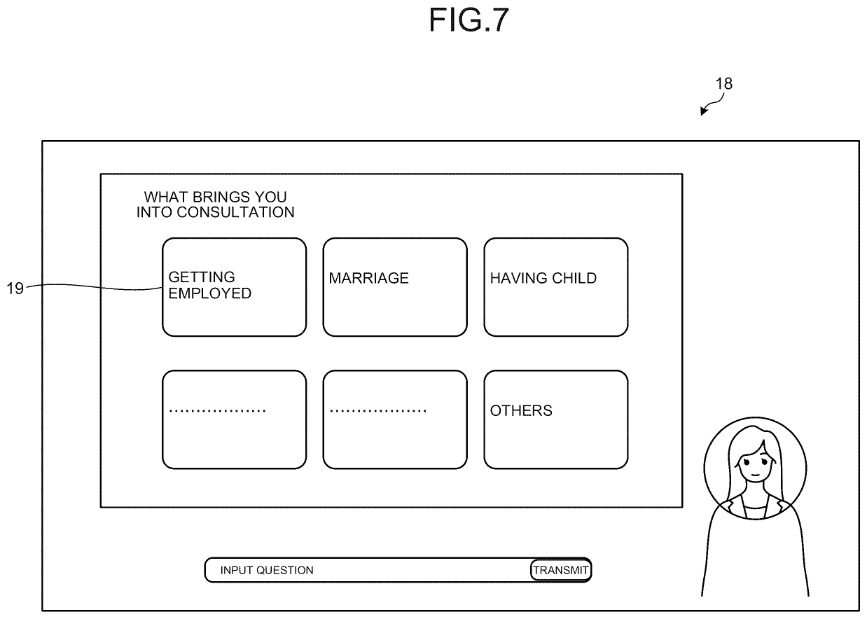

Subsequently, various input screens, life plan chart screens, and the like will be described with reference to FIGS. 7 to 12. FIG. 7 illustrates one example of the user basic information input screen. A screen 18 in FIG. 7 is provided for asking about what brings the user into consultation when user basic information is input. The screen 18 includes a plurality of buttons 19 corresponding to a plurality of triggers of consultation. When the user selects any button 19, the screen 18 transitions to an input screen for inputting the name, age, and the like of the user.

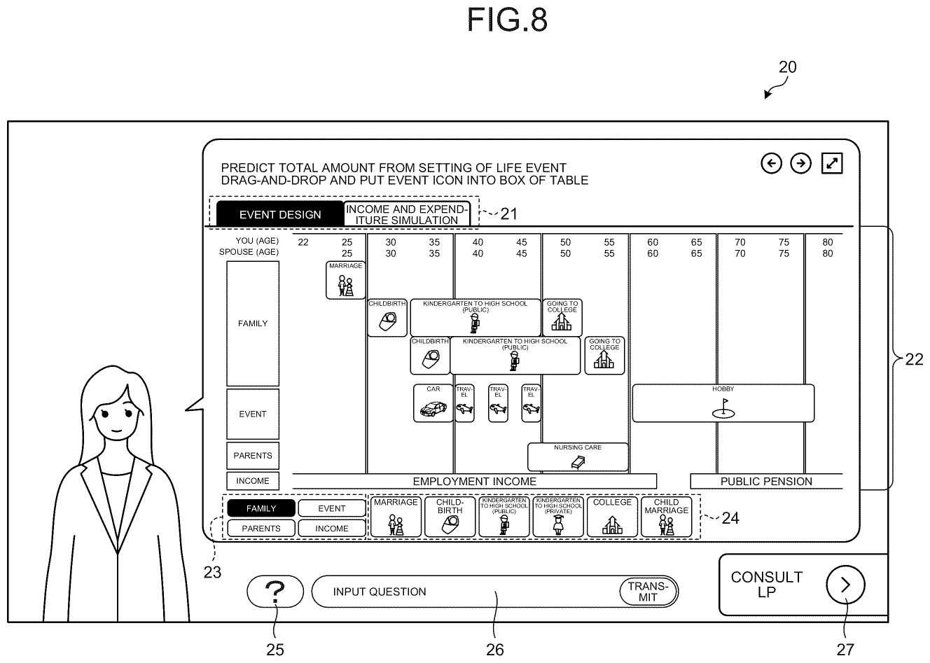

FIG. 8 illustrates one example of a life event input screen. A screen 20 in FIG. 8 receives input of a life event in the life plan chart of the user. A tab region 21 includes an event design tab and an income and expenditure simulation tab, which can be switched between by user selection. The event design tab is now displayed on the screen 20. In the event design tab, event icons may be arranged in an arrangement region 22. The event icons are arranged in the arrangement region 22 by, for example, a drag-and-drop operation from an icon group 24 in classification selected through a classification group 23. Note that the screen 20 includes a button 25, a question input field 26, and a button 27. The button 25 is provided for referring to help. The question input field 26 is provided for the AI agent to respond to a question. The button 27 is provided for transitioning to a screen for consulting an LP. The screen 20 is one example of the ideal plan input screen. The user can input ideal plan information on the screen 20.

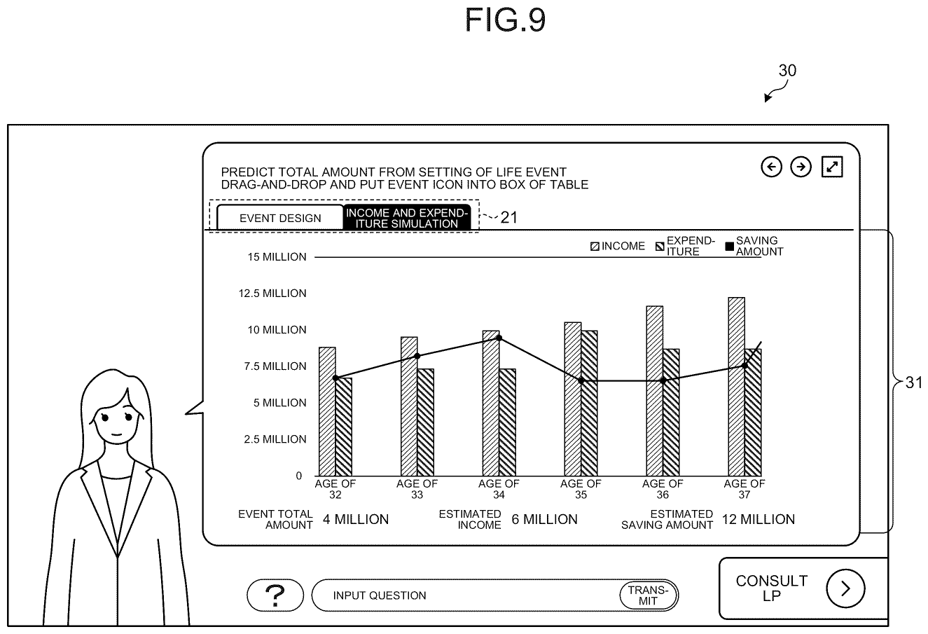

FIG. 9 illustrates one example of an income and expenditure simulation screen. The income and expenditure simulation tab is now displayed on a screen 30 in FIG. 9. In the income and expenditure simulation tab, income and expenditure simulation within a predetermined period, that is, items such as estimated income, expenditure, and saving amount are graphically displayed in a region 31. The user can return to the screen 20 by selecting the event design tab in the tab region 21. The screen 30 is displayed, for example, when the user wants to check a specific period in the middle of input on the ideal plan input screen.

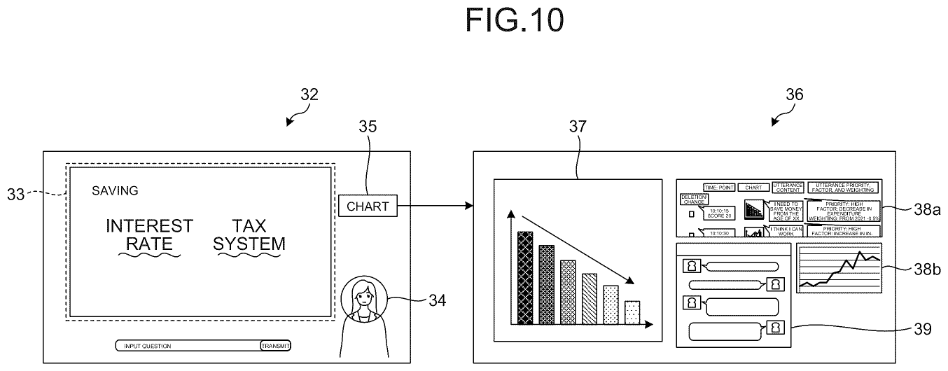

FIG. 10 illustrates one example of an explanation screen and a life plan chart screen. A screen 32 in FIG. 10 is provided for describing a document 33. In the document 33, an LP/FP is displayed on the screen. The example of FIG. 10 assumes a scene where the user meets the LP/FP in an online conference system, for example. A face image 34 may be a moving image obtained by photographing the LP/FP during the meeting. When the user receives explanation of a document 33 from the LP/FP and then presses a chart display button 35, a life plan chart screen 36 is displayed based on a result of voice recognition of the contents of the conversation between the user and the LP/FP. That is, generation of the life plan chart based on the embodiment can be applied not only to conversation between the user and the AI agent but to conversation between the user and the LP/FP. In this case, a burden on the LP/FP in creating the life plan chart can be alleviated. Furthermore, the life plan chart generated by the conversation between the user and the AI agent can be referred to when the user consults the LP/FP at a later date. Note that the screen 32 is omitted in creating the life plan chart based on the conversation between the user and the AI agent.

The life plan chart screen 36 includes, for example, a life plan chart 37, a timeline display 38a, a graph 38b of the timeline display, and a chat area 39. The life plan chart 37 displays a current life plan chart. Note that, in the life plan chart 37, input such as pulling up a chart by an operation of a touch panel or a mouse may be received from the user. In this case, the AI agent may ask a question and the like in accordance with the received contents. The timeline display 38a displays, in a timeline, a history in which the life plan chart has been updated in accordance with the user utterance content. The graph 38b graphs and displays each score in the history of the life plan chart. That is, the graph 38b graphically displays a history of a score of the life plan chart which changes in accordance with the user utterance content. The chat area 39 displays the contents of an interaction between the user and the AI agent in a chat format.

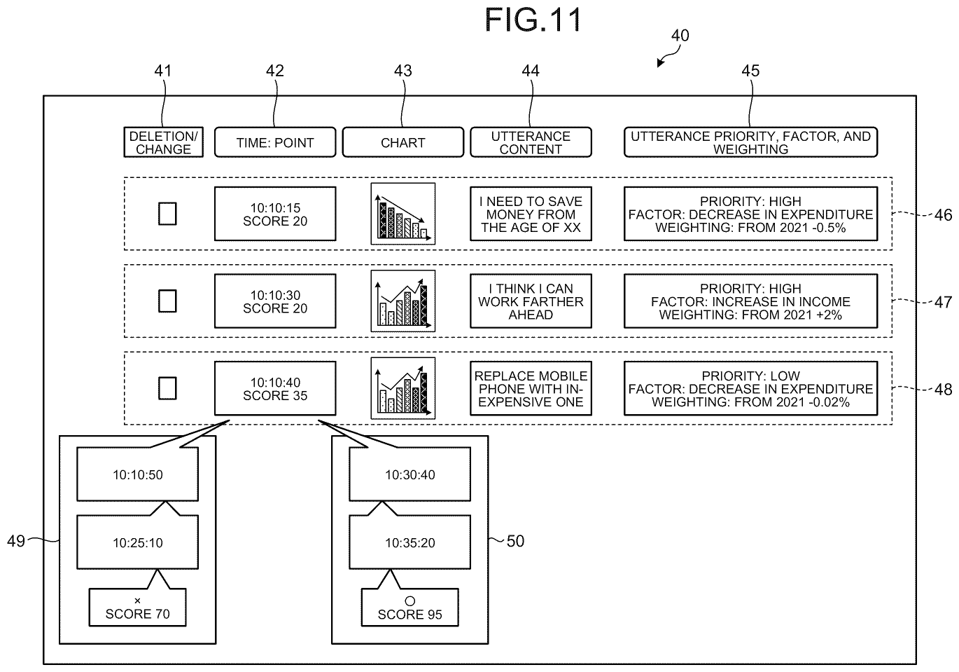

FIG. 11 illustrates one example of the timeline display. A screen 40 in FIG. 11 is displayed by the timeline display 38a of the life plan chart screen 36 in FIG. 10 being selected by a click and the like, for example. The screen 40 includes, as elements, a deletion/change field 41, a time: point field 42, a chart field 43, an utterance content field 44, and a status field 45. In the deletion/change field 41, check boxes are provided, and a history of the life plan chart can be deleted or changed by checking a check box. The time: point field 42 displays the time when the life plan chart was generated and a score of the life plan chart. A reduced image of the life plan chart is displayed in the chart field 43. The utterance content field 44 displays the user utterance content at the time of updating the life plan chart. The status field 45 displays information on why the life plan chart has been updated, such as the user utterance priority, a factor, and weighting at the time of updating the life plan chart.

Histories 46 to 48 are displayed in a timeline in the order from the top on the screen 40. Note that, although sequences 49 and 50 are illustrated for describing how to use the histories, the sequences 49 and 50 are not displayed on the screen 40. First, following the history 48, as illustrated in the sequence 49, the life plan chart is assumed to have been updated twice to have a score of “70”. Then, the user is assumed to restart from the history 48. In the restarted history, as illustrated in the sequence 50, the life plan chart is assumed to have been updated twice to have a score of “95”. As described above, in the timeline display, any history of the life plan chart is selected, and thus the life plan chart can be updated from the selected history. Note that the score can have a numerical value within a range of 0 to 100 with an ideal plan as “100”.

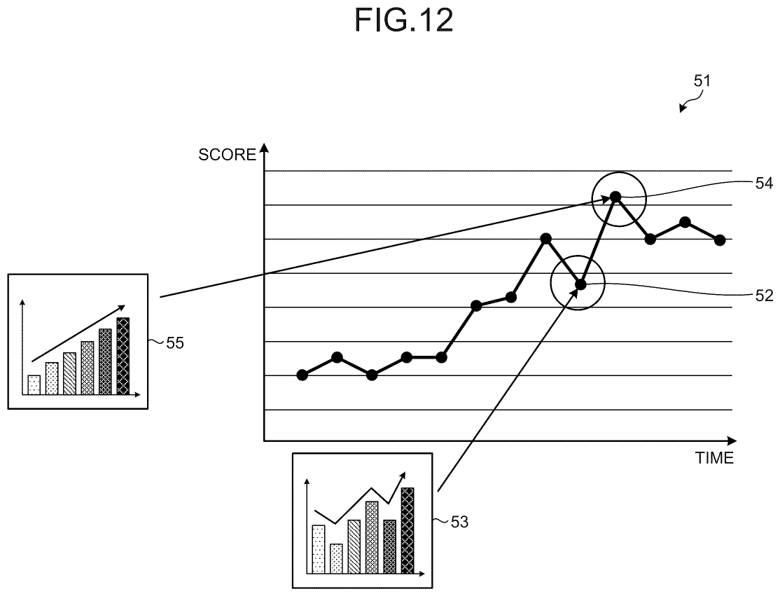

FIG. 12 illustrates one example of timeline display using a graph. A graph 51 in FIG. 12 is obtained by enlarging the graph 38b in FIG. 10. Since the life plan chart rapidly changes by interactions between the user and the AI agent, comparison with a past life plan chart is difficult. Therefore, changes in the life plan chart can be easily known by graphing scores calculated for respective histories of the life plan chart. For example, it is assumed that a history 52 is a chart illustrated in a life plan chart 53 and a history 54 is a chart illustrated in a life plan chart 55. Here, when the history 52 is compared with the history 54, it can be seen that the history 54 is a better life plan chart by looking at the graph 51 of scores.

### [1-5. Procedure of Information Processing According to Embodiment]

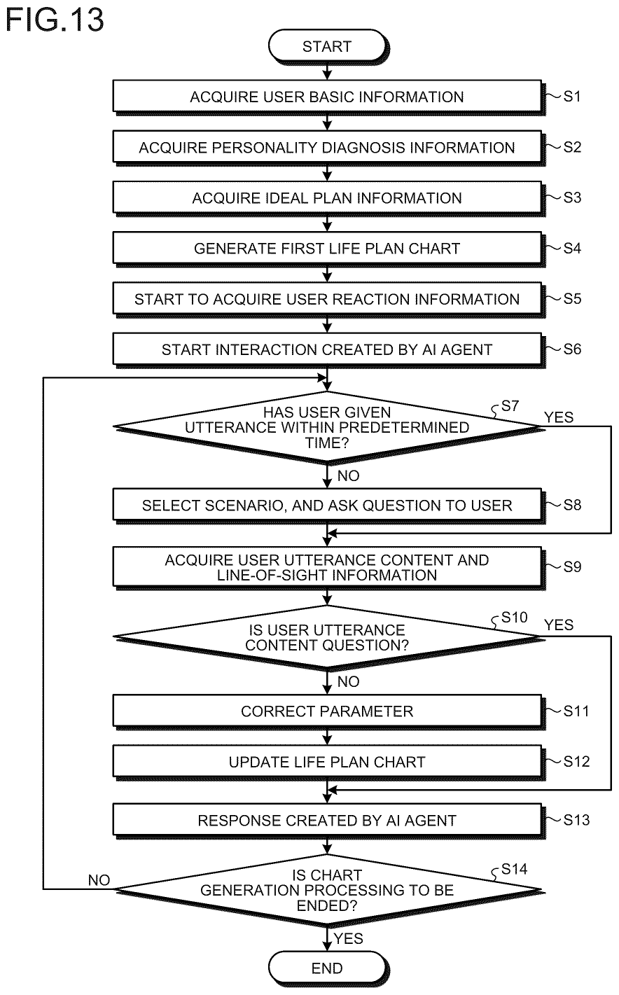

Next, chart generation processing of generating a life plan chart through an interaction with the AI agent will be described with reference to FIG. 13. FIG. 13 is a flowchart illustrating one example of the chart generation processing.

The user information processing unit 231 of the server 200 transmits data of a user basic information input screen to the terminal device 100, and causes the terminal device 100 to display the user basic information input screen. The user information processing unit 231 acquires user basic information input on the displayed basic information input screen (Step S1). The user information processing unit 231 stores the acquired user basic information in the user basic information DB 221.

The user information processing unit 231 transmits data of a personality diagnosis screen to the terminal device 100, and causes the terminal device 100 to display the personality diagnosis screen. The user information processing unit 231 acquires personality diagnosis information input on the displayed personality diagnosis screen (Step S2). The user information processing unit 231 outputs the acquired personality diagnosis information to the personality information processing unit 232. The personality information processing unit 232 diagnoses the personality of the user based on the input personality diagnosis information, and stores the personality diagnosis result in the user basic information DB 221.

The user information processing unit 231 transmits data of an ideal plan input screen to the terminal device 100, and causes the terminal device 100 to display the ideal plan input screen. The user information processing unit 231 acquires ideal plan information input on the displayed ideal plan input screen (Step S3). The user information processing unit 231 stores the acquired ideal plan information in the ideal plan parameter DB 222.

The user information processing unit 231 calculates an initial value of a parameter of a life plan chart based on the user basic information, a personality diagnosis result, and a model case with reference to the user basic information DB 221 and the average income and expenditure DB 228. That is, the user information processing unit 231 generates a first life plan chart (Step S4). The user information processing unit 231 stores the calculated parameter of the life plan chart in the current graph parameter DB 224 and the history data DB 225. Furthermore, the user information processing unit 231 transmits the calculated parameter of the life plan chart to the terminal device 100 as graph information, and displays the life plan chart.

The voice engine unit 240 and the interaction processing unit 260 start to acquire voice information, a line-of-sight position, and area semantic information as user reaction information in the terminal device 100 (Step S5). The interaction generation unit 271 of the interaction processing unit 260 starts an interaction created by the AI agent (Step S6).

The interaction generation unit 271 determines whether or not the user has given utterance within a predetermined time based on semantic analysis result information (Step S7). When determining that the user has not given utterance within the predetermined time (Step S7: No), the interaction generation unit 271 selects a scenario of interacting with the user as the AI agent with reference to the scenario DB 262. The interaction generation unit 271 asks a question to the user in accordance with the selected scenario (Step S8). The interaction generation unit 271 acquires the user utterance content and line-of-sight information from the terminal device 100 (Step S9). In contrast, when determining that the user has given utterance within the predetermined time (Step S7: Yes), the interaction generation unit 271 proceeds to Step S8 without asking a question to the user.

The interaction generation unit 271 determines whether or not the acquired user utterance content is a question (Step S10). When the user utterance content is not a question (Step S10: No), the interaction generation unit 271 instructs the parameter processing unit 233 to correct a parameter of the life plan chart in accordance with the utterance content and the line-of-sight information and update the life plan chart (Steps S11 and S12). The interaction generation unit 271 generates an interaction such as a response suitable for the corrected life plan chart. That is, the interaction generation unit 271 gives a response created by the AI agent (Step S13).

In contrast, when the user utterance content is a question (Step S10: Yes), the interaction generation unit 271 gives a response with reference to each DB such as the scenario DB 262 and the advice DB 263 in accordance with the utterance content and the line-of-sight information. That is, the interaction generation unit 271 gives a response created by the AI agent (Step S13).

The interaction generation unit 271 determines whether or not the current scenario has ended, that is, whether or not to end chart generation processing (Step S14). When the chart generation processing is not ended (Step S14: No), the interaction generation unit 271 returns to Step S7 and waits for a user utterance, or proceeds to the next item of the scenario and continues to interact with the user. In contrast, when determining to end the chart generation processing (Step S14: Yes), the interaction generation unit 271 notifies the user that the generation of the life plan chart is to be ended, and ends the processing. This enables the life plan chart reflecting the utterance content to be immediately checked.

[1-6. Flow of Processing in Interaction Created by AI agent]

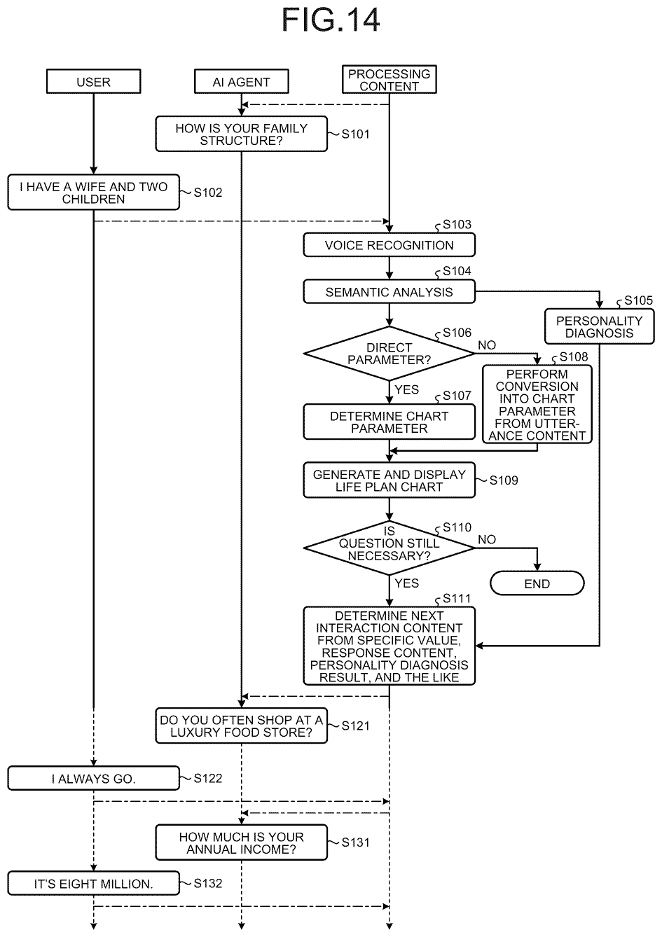

Subsequently, a flow of processing in an interaction created by the AI agent to a specific question will be described with reference to FIGS. 14 to 16. Note that, in the description of FIGS. 14 to 16, a subject of processing executed in the information processing system 1 will be described as the AI agent.

FIG. 14 is a sequence diagram illustrating one example of processing related to an exchange between the user and the AI agent in Case 1. In Case 1 in FIG. 14, first, the AI agent asks the user a question “How is your family structure?” (Step S101). The user responds, “I have a wife and two children.” (Step S102). The AI agent performs voice recognition (Step S103), and performs semantic analysis (Step S104). Furthermore, the AI agent performs personality diagnosis based on data preliminarily input on the personality diagnosis screen (Step S105). Note that the personality diagnosis result in Step S105 is to be used in Step S111 to be described later.

The AI agent determines whether or not the semantic analysis result information is a direct parameter for the life plan chart (Step S106). When determining that the semantic analysis result information is a direct parameter (Step S106: Yes), the AI agent determines a chart parameter from the semantic analysis result information (Step S107). In contrast, when determining that the semantic analysis result information is not a direct parameter (Step S106: No), the AI agent performs conversion into a chart parameter from the utterance content (Step S108).

Here, one example of parameter conversion will be described. For example, when the utterance content is “I think I will work after retirement.”, “ID_WORK_AFTER_RETIRE positive_flag” is obtained as the semantic analysis result information. Since “ID_WORK_AFTER_RETIRE positive_flag” of the semantic analysis result information is not a direct parameter for the chart, parameters of the ages of 60 to 65 among annual income parameters of the chart are increased by 2.3 million yen. Furthermore, for example, when the utterance content is “Nursing care for parents may be difficult.”, “ID_CARE_FOR_PARENTS negative_flag” is obtained as the semantic analysis result information. Since “ID_CARE_FOR_PARENTS negative_flag” of the semantic analysis result information is not a direct parameter for the chart, expenditure parameters of the chart are increased by 40 thousand yen from the current time. Furthermore, for example, when the utterance content is “I want to change my job after five years to get a salary increase of three million.”, “ID_CHANGE_OCCUPATION positive_flag SLOT after five years three million” is obtained as the semantic analysis result information. Since “ID_CHANGE_OCCUPATION positive_flag SLOT after five years three million” of the semantic analysis result information is not a direct parameter for the chart, annual income parameters of the chart are increased by three million yen from after five years.

The AI agent generates and displays the life plan chart based on the chart parameter (Step S109). The AI agent determines whether or not a question is still necessary for generating the life plan chart (Step S110). When determining that a question is still necessary (Step S110: Yes), the AI agent determines the next interaction content from a specific value of the chart parameter, the response content, the personality diagnosis result, and the like (Step S111). Thereafter, for example, the processing of Steps S103 to S111 is repeated based on a question such as “Do you often shop at a luxury food store?” in Step S121 and a response such as “I always go.” in Step S122. Similarly, for example, the processing of Steps S103 to S111 is repeated based on a question such as “How much is your annual income?” in Step S131 and a response such as “It's eight million.” in Step S132.

In contrast, when determining in Step S110 that a question is not necessary (Step S110: No), the AI agent ends the exchange with the user. This enables the life plan chart reflecting the utterance content to be immediately checked.

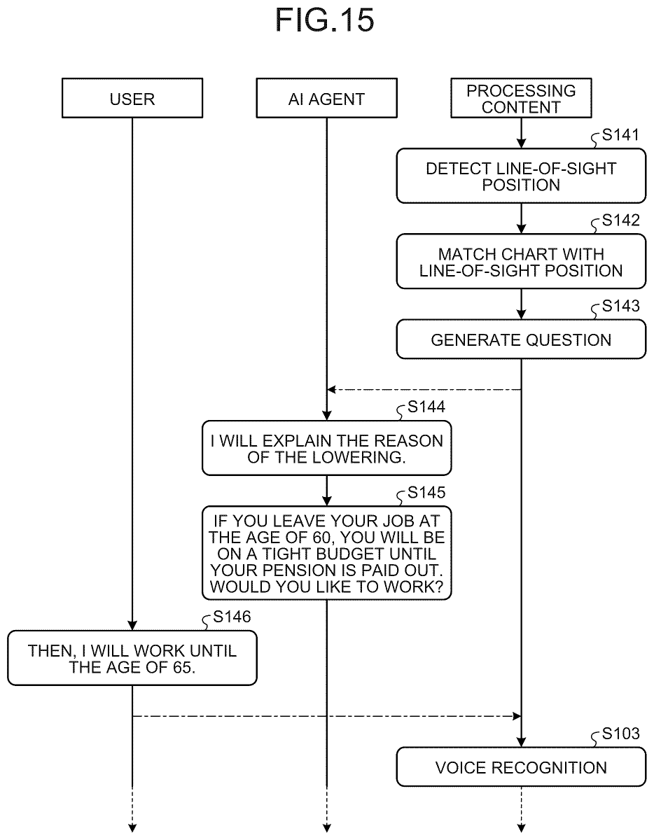

FIG. 15 is a sequence diagram illustrating one example of processing related to an exchange between the user and the AI agent in Case 2. In Case 2 in FIG. 15, when the user is looking at the displayed life plan chart, the AI agent detects a line-of-sight position (Step S141).

The AI agent matches the life plan chart with the line-of-sight position (Step S142), and generates a question regarding a region of the life plan chart that the user is gazing at (Step S143).

When the user is gazing at a region of the age of 60 in the life plan chart, the AI agent responds, “I will explain the reason of the lowering.”, for example (Step S144). Furthermore, the AI agent continues to ask a question “If you leave your job at the age of 60, you will be on a tight budget until your pension is paid out. Would you like to work?”, for example (Step S145). Note that the response in Step S144 is not required to be given. When the user responds, “Then, I will work until the age of 65.” to the question of the AI agent (Step S146), the AI agent performs voice recognition (Step S103), and then executes Steps S104 to S111 as in FIG. 14. This enables the life plan chart reflecting the line-of-sight position and the utterance content to be immediately checked.

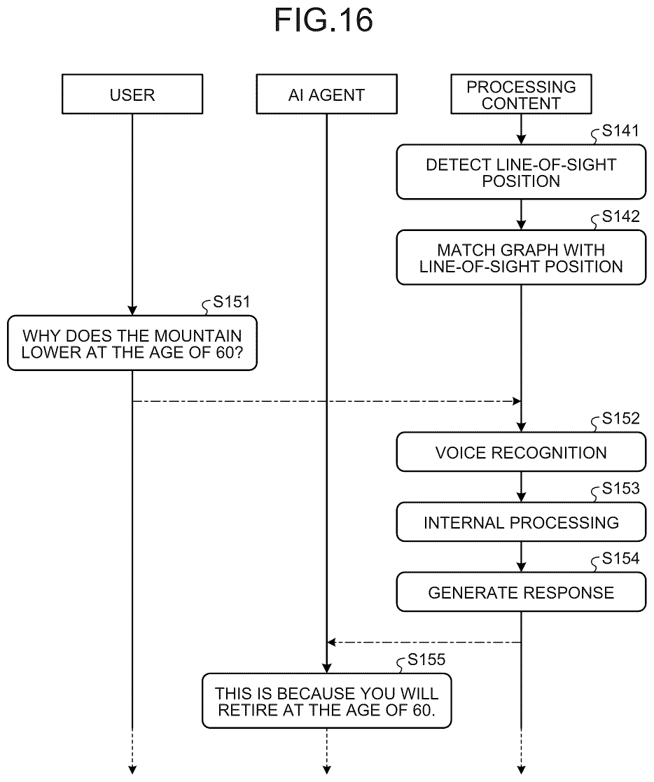

FIG. 16 is a sequence diagram illustrating one example of processing related to an exchange between the user and the AI agent in Case 3. In Case 3 in FIG. 16, as in FIG. 15, when the user is looking at the displayed life plan chart, the AI agent detects a line-of-sight position (Step S141). The AI agent matches the life plan chart with the line-of-sight position (Step S142). Here, for example, when the user asks a question such as “Why does the mountain lower at the age of 60?” (Step S151), the AI agent performs voice recognition (Step S152), performs semantic analysis, reference to a scenario, and the like as internal processing (Step S153), and generates a response (Step S154). The AI agent gives a response such as “This is because you will retire at the age of 60.” as the generated response (Step S155). Thereafter, Steps S103 to S111 are executed as in FIG. 14. This enables the life plan chart reflecting the line-of-sight position and the utterance content to be immediately checked.

### (2. Variations of Embodiment)

The processing according to the above-described embodiment may be conducted in various different forms other than the above-described embodiment.

Although, in the above-described embodiment, a case where the life plan chart is created based on an exchange between the user and the AI agent has been described as one example, this is not a limitation. For example, the present disclosure can also be applied to FP/LP education, support of carrier consultant business, curriculum organization consultation in various schools, cram schools, and the like, consultation on various requirements in marriage information introduction service, and simulation of estimation in house purchase.

In addition, the processing procedures, the specific names, and information including various pieces of data and parameters in the above-described document and drawings can be optionally changed unless otherwise specified. For example, various pieces of information in each figure are not limited to the illustrated information.

Furthermore, each component of each illustrated device is functional and conceptual, and does not necessarily need to be physically configured as illustrated. That is, the specific form of distribution/integration of each device is not limited to the illustrated one, and all or part of the device can be configured in a functionally or physically distributed/integrated manner in any unit in accordance with various loads and use situations. For example, the terminal device 100 may integrate the functions of the voice engine unit 240 and the interaction processing unit 260 of the server 200.

Furthermore, the above-described embodiment and variations thereof can be appropriately combined as long as the processing contents do not contradict each other.

### (3. Hardware Configuration)

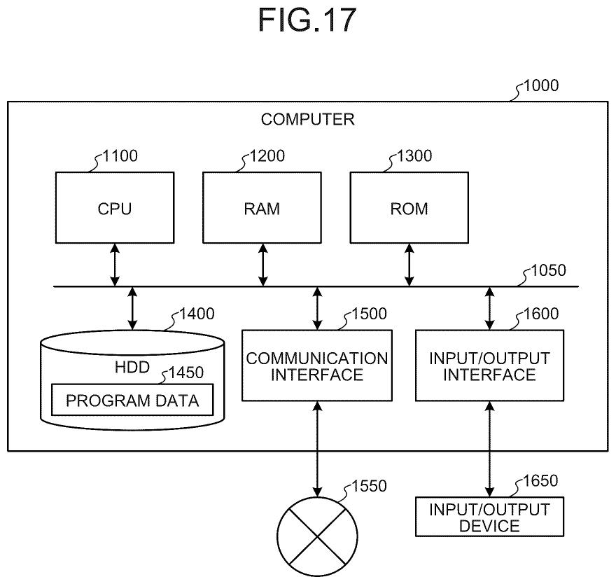

Information equipment such as the terminal device 100 and the server 200 according to the above-described embodiment is implemented by a computer 1000 having a configuration as illustrated in FIG. 17, for example. Description will be given below by using the server 200, which is an information processing device according to the embodiment, as an example. FIG. 17 is a hardware configuration diagram illustrating one example of a computer that implements the function of the information processing device. The computer 1000 includes a CPU 1100, a RAM 1200, a read only memory (ROM) 1300, a hard disk drive (HDD) 1400, a communication interface 1500, and an input/output interface 1600. Units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 on the RAM 1200, and executes processing corresponding to various programs.

The ROM 1300 stores a boot program such as a basic input output system (BIOS) executed by the CPU 1100 at the time when the computer 1000 is started, a program depending on the hardware of the computer 1000, and the like.

The HDD 1400 is a computer-readable recording medium that non-transiently records a program to be executed by the CPU 1100, data to be used by the program, and the like. Specifically, the HDD 1400 is a recording medium that records an information processing program according to the present disclosure. The information processing program is one example of program data 1450.

The communication interface 1500 is used for connecting the computer 1000 with an external network 1550 (e.g., Internet). For example, the CPU 1100 receives data from another piece of equipment and transmits data generated by the CPU 1100 to another piece of equipment via the communication interface 1500.

The input/output interface 1600 connects an input/output device 1650 with the computer 1000. For example, the CPU 1100 receives data from an input device such as a keyboard and a mouse via the input/output interface 1600. Furthermore, the CPU 1100 transmits data to an output device such as a display, a speaker, and a printer via the input/output interface 1600. Furthermore, the input/output interface 1600 may function as a medium interface that reads a program and the like recorded in a predetermined recording medium (medium). The medium includes, for example, an optical recording medium such as a digital versatile disc (DVD) and a phase change rewritable disk (PD), a magneto-optical recording medium such as a magneto-optical disk (MO), a tape medium, a magnetic recording medium, and a semiconductor memory.

For example, when the computer 1000 functions as the server 200 according to the embodiment, the CPU 1100 of the computer 1000 implements the functions of the user information processing unit 231 and the like by executing an information processing program loaded on the RAM 1200. Furthermore, the HDD 1400 stores an information processing program according to the present disclosure and data such as the user basic information DB 221. Note that the CPU 1100 reads the program data 1450 from the HDD 1400 and executes the program data 1450. In another example, the CPU 1100 may acquire these programs from another device via the external network 1550.

### (4. Effects)

The information processing system 1 generates and displays plan information representing a future plan based on user basic information and an ideal plan of the user in consultation on the future plan of the user through a voice interaction. The information processing system 1 corrects the future plan and updates the plan information in accordance with information on reaction of the user to the displayed plan information. As a result, the plan information reflecting the user reaction information can be immediately checked.

The reaction information relates to a line of sight of the user. As a result, the line of sight of the user can be reflected in the plan information.

The reaction information relates to the user utterance content. As a result, the user utterance content can be reflected in the plan information.

The future plan relates to a life plan. As a result, the life plan chart (plan information) reflecting the user reaction information can be immediately checked.

The plan information is the life plan chart. As a result, the life plan chart reflecting the user reaction information can be immediately checked.

The voice interaction is created between the user and the AI agent. As a result, the AI agent can guide the user to generate the plan information.

Moreover, the AI agent asks a question to the user about information lacked in the plan information. Furthermore, the AI agent (update unit) corrects the future plan and updates the plan information in accordance with the response of the user. As a result, the AI agent can find out information necessary for generating the plan information from the user, and reflects the information in the plan information.

The AI agent asks a question to the user based on a region to which the line of sight of the user is directed and one or a plurality of user utterance contents, which are pieces of reaction information. As a result, the AI agent can ask a question about a matter in which the user is interested.

The AI agent changes the contents of the question in accordance with the attribute of the user. As a result, the life plan chart (plan information) more desired by the user can be generated.

Moreover, when the user asks a question about a region to which the line of sight of the user for the plan information is directed, the AI agent gives a response in accordance with the region and the contents of the question. As a result, an appropriate response can be given for a question of the user.

Moreover, the AI agent asks the user a question regarding correction of the future plan about the region to which the line of sight of the user is directed for the plan information. Furthermore, the AI agent corrects the future plan and updates the plan information in accordance with the response of the user. As a result, the life plan chart (plan information) of the region in which the user is interested can be corrected.

Moreover, the AI agent determines whether the voice interaction is in the chat phase or in the consultation phase. When determining that the voice interaction is in the consultation phase, the AI agent gives a question or a response to the user. As a result, extra information in a chat can be excluded.

Moreover, when a certainty factor of semantic analysis on a user utterance content is low or the plan information greatly changes, the AI agent gives a response for making a check to the user. As a result, information with low reliability can be excluded.

Moreover, when there is a plurality of users, the AI agent identifies a decision maker in accordance with the number of utterances contributing to the plan information. The AI agent (update unit) corrects the future plan and updates the plan information in accordance with the content of an utterance of the identified decision maker. As a result, rework at the time of generating the life plan chart (plan information) can be reduced.

When the plan information is updated, the AI agent displays a history of updates in a timeline. As a result, each corrected life plan chart (plan information) can be displayed.

Moreover, the AI agent calculates a score for an ideal plan of the updated plan information. Furthermore, the AI agent displays the calculated score in the timeline. As a result, at which time point the life plan chart (plan information) is close to the ideal plan can be clearly displayed.

The AI agent graphically displays the score. As a result, at which time point the life plan chart (plan information) is close to the ideal plan can be displayed so as to be recognized at a glance.

The voice interaction is created between the user and a person in charge. As a result, a burden on the person in charge in creating the life plan chart (plan information) can be alleviated.

The server 200 includes an acquisition unit, a generation unit, and an update unit (user information processing unit 231 and parameter processing unit 233). The acquisition unit acquires user reaction information, user basic information, and an ideal plan of the user in consultation on the future plan of the user through a voice interaction. The generation unit generates plan information representing a future plan based on the acquired basic information and the ideal plan. The update unit corrects the future plan and updates the plan information in accordance with reaction information to the generated plan information. As a result, the plan information reflecting the user reaction information can be immediately checked.

Note that the effects described in the present specification are merely examples and not limitations. Other effects may be obtained.

Note that the present technology can also have the configurations as follows.

(1)

An information processing method performed by a computer, the method comprising:
displaying plan information, the plan information representing a future plan and being generated based on basic information on a user and an ideal plan of the user in consultation on the future plan of the user through a voice interaction; and
correcting the future plan and updating the plan information in accordance with information on reaction of the user to the plan information that has been displayed.
   (2)

The information processing method according to (1),
wherein the information on reaction relates to a line of sight of the user.
   (3)

The information processing method according to (1) or (2),
wherein the information on reaction relates to an utterance content of the user.
   (4)

The information processing method according to any one of (1) to (3),
wherein the future plan relates to a life plan.
   (5)

The information processing method according to any one of (1) to (4),
wherein the plan information is a life plan chart.
   (6)

The information processing method according to any one of (1) to (5),
wherein the voice interaction is created between the user and an artificial intelligence (AI) agent.
   (7)

The information processing method according to (6),
wherein a computer further executes processing of causing the AI agent to ask the user a question about information lacked in the plan information, and
the future plan is corrected in accordance with a response of the user and the plan information is updated in processing of the updating.
   (8)

The information processing method according to (7),
wherein, in the processing of asking, a question is asked to the user based on a region to which a line of sight of the user is directed and one or a plurality of utterance contents of the user, which are the information on reaction.
   (9)

The information processing method according to (7) or (8),
wherein, in the processing of asking, a content of the question is changed in accordance with an attribute of the user.
   (10)

The information processing method according to any one of (6) to (9),
wherein a computer further executes processing of causing the AI agent to give a response in accordance with a region and a content of a question when the user asks the question about the region to which a line of sight of the user for the plan information is directed.
   (11)

The information processing method according to any one of (6) to (10),
wherein a computer further executes processing of causing the AI agent to ask the user a question regarding correction of the future plan about the region to which a line of sight of the user for the plan information is directed, and
the future plan is corrected in accordance with a response of the user and the plan information is updated in the processing of the updating.
   (12)

The information processing method according to any one of (6) to (11),
wherein a computer further executes processing of causing the AI agent to determine whether the voice interaction is in a chat phase or in a consultation phase, and, when determining that the voice interaction is in the consultation phase, gives a question or a response to the user.
   (13)

The information processing method according to any one of (6) to (12),
wherein a computer further executes processing of causing the AI agent to give a response for making a check to the user when a certainty factor of semantic analysis on an utterance content of the user is low or the plan information greatly changes.
   (14)

The information processing method according to any one of (6) to (13),
wherein a computer further executes processing of identifying a decision maker in accordance with a number of utterances contributing to the plan information when there is a plurality of users, and
the future plan is corrected in accordance with an utterance content of the decision maker who has been identified in the processing of the updating.
   (15)

The information processing method according to any one of (1) to (14),
wherein the displaying comprises displaying a history of updates in a timeline in response to the updating of the plan information.
   (16)

The information processing method according to (15),
wherein a computer further executes processing of calculating a score for the ideal plan of the plan information that has been updated, and
the score calculated in the timeline is displayed in the display processing.
   (17)

The information processing method according to (16),
wherein the score is graphically displayed in the display processing.
   (18)

The information processing method according to any one of (1) to (5),
wherein the voice interaction is created between the user and a person in charge.
   (19)

An information processing device comprising:
an acquisition unit that acquires information on reaction of a user, basic information on the user, and an ideal plan of the user in consultation on a future plan of the user through a voice interaction;
a generation unit that generates plan information representing the future plan based on the basic information and the ideal plan which have been acquired; and
an update unit that corrects the future plan and updates the plan information in accordance with the information on reaction to the plan information that has been generated.
   (20)

An information processing program causing a computer to:
display plan information, the plan information representing a future plan and being generated based on basic information on a user and an ideal plan of the user in consultation on the future plan of the user through a voice interaction; and
correct the future plan and update the plan information in accordance with the information on reaction of the user to the plan information that has been displayed.

### REFERENCE SIGNS LIST

1 INFORMATION PROCESSING SYSTEM
100 TERMINAL DEVICE
101 DISPLAY UNIT
102 OPERATION UNIT
103 CAMERA
104 MICROPHONE
105 SPEAKER
110 COMMUNICATION UNIT
120 STORAGE UNIT
121 LINE-OF-SIGHT POSITION STORAGE UNIT
122 AREA SEMANTIC INFORMATION STORAGE UNIT
130 CONTROL UNIT
131 RECEPTION UNIT
132 GRAPH DISPLAY UNIT
133 LINE-OF-SIGHT DETECTION UNIT
134 CORRESPONDING POSITION DETECTION UNIT
135 VOICE PROCESSING UNIT
200 SERVER
210 COMMUNICATION UNIT
220 GRAPH PROCESSING UNIT
221 USER BASIC INFORMATION DB
222 IDEAL PLAN PARAMETER DB
223 USER EVENT DB
224 CURRENT GRAPH PARAMETER DB
225 HISTORY DATA DB
226 SCORE INFORMATION DB
227 EVENT IMPORTANCE DETERMINATION DB
228 AVERAGE INCOME AND EXPENDITURE DB
229 WEIGHTING DB
231 USER INFORMATION PROCESSING UNIT
232 PERSONALITY INFORMATION PROCESSING UNIT
233 PARAMETER PROCESSING UNIT
240 VOICE ENGINE UNIT
241 UTTERANCE HISTORY DB
242 SEMANTIC ANALYSIS DB
251 VOICE RECOGNITION UNIT
252 SEMANTIC ANALYSIS UNIT
253 VOICE SYNTHESIS UNIT
260 INTERACTION PROCESSING UNIT
261 IMPORTANT WORD DB
262 SCENARIO DB
263 ADVICE DB
264 AI UTTERANCE HISTORY DB
271 INTERACTION GENERATION UNIT
272 INCOME AND EXPENDITURE INFORMATION CALCULATION UNIT
273 PROFICIENCY DETERMINATION UNIT
N NETWORK

1. An information processing method performed by a computer, the method comprising:
displaying plan information, the plan information representing a future plan and being generated based on basic information on a user and an ideal plan of the user in consultation on the future plan of the user through a voice interaction; and
correcting the future plan and updating the plan information in accordance with information on reaction of the user to the plan information that has been displayed.

2. The information processing method according to claim 1,
wherein the information on reaction relates to a line of sight of the user.

3. The information processing method according to claim 1,
wherein the information on reaction relates to an utterance content of the user.

4. The information processing method according to claim 1,
wherein the future plan relates to a life plan.

5. The information processing method according to claim 1,
wherein the plan information is a life plan chart.

6. The information processing method according to claim 1,
wherein the voice interaction is created between the user and an artificial intelligence (AI) agent.

7. The information processing method according to claim 6,
wherein a computer further executes processing of causing the AI agent to ask the user a question about information lacked in the plan information, and
the future plan is corrected in accordance with a response of the user and the plan information is updated in processing of the updating.

8. The information processing method according to claim 7,
wherein, in the processing of asking, a question is asked to the user based on a region to which a line of sight of the user is directed and one or a plurality of utterance contents of the user, which are the information on reaction.

9. The information processing method according to claim 7,
wherein, in the processing of asking, a content of the question is changed in accordance with an attribute of the user.

10. The information processing method according to claim 6,
wherein a computer further executes processing of causing the AI agent to give a response in accordance with a region and a content of a question when the user asks the question about the region to which a line of sight of the user for the plan information is directed.

11. The information processing method according to claim 6,
wherein a computer further executes processing of causing the AI agent to ask the user a question regarding correction of the future plan about the region to which a line of sight of the user for the plan information is directed, and
the future plan is corrected in accordance with a response of the user and the plan information is updated in the processing of the updating.

12. The information processing method according to claim 6,
wherein a computer further executes processing of causing the AI agent to determine whether the voice interaction is in a chat phase or in a consultation phase, and, when determining that the voice interaction is in the consultation phase, gives a question or a response to the user.

13. The information processing method according to claim 6,
wherein a computer further executes processing of causing the AI agent to give a response for making a check to the user when a certainty factor of semantic analysis on an utterance content of the user is low or the plan information greatly changes.

14. The information processing method according to claim 6,
wherein a computer further executes processing of identifying a decision maker in accordance with a number of utterances contributing to the plan information when there is a plurality of users, and
the future plan is corrected in accordance with an utterance content of the decision maker who has been identified in the processing of the updating.

15. The information processing method according to claim 1,
wherein the displaying comprises displaying a history of updates in a timeline in response to the updating of the plan information.

16. The information processing method according to claim 15,
wherein a computer further executes processing of calculating a score for the ideal plan of the plan information that has been updated, and
the score calculated in the timeline is displayed in the display processing.

17. The information processing method according to claim 16,
wherein the score is graphically displayed in the display processing.

18. The information processing method according to claim 1,
wherein the voice interaction is created between the user and a person in charge.

19. An information processing device comprising:
an acquisition unit that acquires information on reaction of a user, basic information on the user, and an ideal plan of the user in consultation on a future plan of the user through a voice interaction;
a generation unit that generates plan information representing the future plan based on the basic information and the ideal plan which have been acquired; and
an update unit that corrects the future plan and updates the plan information in accordance with the information on reaction to the plan information that has been generated.

20. An information processing program causing a computer to:
display plan information, the plan information representing a future plan and being generated based on basic information on a user and an ideal plan of the user in consultation on the future plan of the user through a voice interaction; and
correct the future plan and update the plan information in accordance with the information on reaction of the user to the plan information that has been displayed.
